(19) United States
(12) Patent Application Publication
(10) Pub. No.: US 2025/0121493 A1
(43) Pub. Date: Apr. 17, 2025

(54) DIFFERENTIAL KINEMATICS CONTROL USING CONFORMAL GEOMETRIC ENTITY MODELING

(71) Applicant: Intel Corporation, Santa Clara, CA (US)

(72) Inventors: Julio Zamora Esquivel, West Sacramento, CA (US); Alberto Jaimes Pita, Zapopan (MX); David Gonzalez Aguirre, Hillsboro, OR (US); Javier Felip Leon, Hillsboro, OR (US); Rodrigo Aldana Lopez, Zapopan (MX); Edgar Macias Garcia, Zapopan (MX); David Gomez Gutierrez, Tlaquepaque (MX)

(21) Appl. No.: 19/001,854

(22) Filed: Dec. 26, 2024

(51) Int. Cl. B25J 9/16

(52) U.S. Cl. CPC B25J 9/1605; B25J 9/163; B25J 9/1679

(57) ABSTRACT

Techniques are disclosed to implement a mathematical framework to model a mechanical actuator such as robotic arm and compute the differential kinematics of an end effector represented by a circle in a three-dimensional space, described as a bi-vector of conformal geometric algebra. Additionally, by using a circle to describe the grasping pose on the object, a differential kinematics-based control scheme is implemented to guide the actuator and minimize the error between the end effector circle and the target circle. The circle has 3 degrees of freedom for the center, two degrees for the orientation, and one more for the radius, which may be used to describe the end effector pose, with the differential kinematics-based control scheme law adjusting the position and the orientations simultaneously.

### TECHNICAL FIELD

Aspects described herein generally relate to techniques for control systems and, more particularly, to techniques implementing control systems using conformal geometric entity modeling of components of mechanical actuators.

### BACKGROUND

Mechanical actuators such as robotic arms are often implemented in industrial and other settings to perform various tasks, which may be related to manufacturing and/or semi-autonomous operations such as gripping, cutting, drilling, sanding, deburring, welding, polishing, etc. To do so, the mechanical actuator typically includes an arm having one or more movable joints as well as a device, referred to as an “end effector,” which attaches to the end of the arm to enable it to interact with its environment and perform such tasks. These end effectors are also known as “end-of-arm tooling” (EOAT) or “manipulators.” To perform such tasks, a control system is used to move the arm into a specific position and orientation (also known as a pose) that corresponds to the particular task that is to be performed. This often requires the need to adjust the movable joints such that the end effector is in a specific position and orientation with respect to a target object on which the task is to be performed. However, conventional control solutions to control the movement of mechanical actuators in this way require significant computational power. Thus, current techniques to perform end effector pose control for such mechanical actuators have been inadequate.

### BRIEF DESCRIPTION OF THE DRAWINGS/FIGURES

The accompanying drawings, which are incorporated herein and form a part of the specification, illustrate the aspects of the present disclosure and, together with the description, and further serve to explain the principles of the aspects and to enable a person skilled in the pertinent art to make and use the aspects.

FIG. 1 illustrates a block diagram of an environment utilizing mechanical actuators to perform tasks, in accordance with the disclosure;

FIGS. 2A and 2B illustrate representations of an end effector and a target object, respectively, modeled as conformal geometric entities comprising circles;

FIG. 3 illustrates a representation of a robotic arm including several movable joints and their corresponding axes of rotation; and

FIG. 4 illustrates a process flow, in accordance with the disclosure.

The exemplary aspects of the present disclosure will be described with reference to the accompanying drawings. The drawing in which an element first appears is typically indicated by the leftmost digit(s) in the corresponding reference number.

### DETAILED DESCRIPTION

In the following description, numerous specific details are set forth in order to provide a thorough understanding of the aspects of the present disclosure. However, it will be apparent to those skilled in the art that the aspects, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

Again, conventional solutions to control the mechanical actuation of robotics arms and their overall pose, which includes the pose of their end effectors to perform specific tasks, have been inadequate. For instance, techniques have been proposed to integrate a dual quaternion-based visual controller with grasping as a control solution. Other solutions include systems that implement dual network-based controllers, which typically comprise a robotic system, a rough-reaching movement controller, and a correction movement controller. Such rough-reaching movement controllers are generally implemented by a pre-trained radial basis function (RBF) Neural Network (NN), which is made of several (e.g. 55) hidden nodes. Correction movement controllers are generally constructed using a Brain Emotional Nesting Network (BENN) and a robust controller. Additionally, techniques have been proposed for a visual perception module that effectively integrates a high-rate, model-based 6D pose tracking system with an accurate, learning-based 6D object pose localization approach.

However, each of these conventional systems suffers from various drawbacks, which the control system as described further herein addresses. For instance, the aspects described herein are directed to the use of a conformal geometry based control system that models the end effector and target object in terms of conformal geometric entities such as circles. In doing so, the conformal geometry based control system as described in further detail herein presents a solution to under constrained inverse kinematics problems, which is both higher precision and more efficient than existing approaches. To do so, properties of geometric algebra are exploited that recognize circles may be described as bivectors in conformal geometric algebra (CGA). The conformal geometry based control system includes the formulation of techniques to compute the differential kinematics of circles and a differential kinematics control scheme in terms of circles. Doing so considers that an end effector may be modeled as a circle and a target object may be grasped (or otherwise acted on) from any position around the target object by generating a circle of possible solutions. This control technique is particularly useful for grasping shapes with axial symmetries that can be grasped from any position within the modeled end effector circle.

Conventional control systems, in contrast, may be based on linear algebra and the Jacobian pseudo-inverse, which require 64 multiply and accumulate (MAC) operations to concatenate two transformations. The conformal geometry based control system as described herein is more computationally efficient, requiring only 16 MAC operations. Thus, control systems based upon linear algebra may require hardware accelerators given the number of computations required, adding to their cost and complexity. The conformal geometry based control system as further discussed herein provides a more computationally-efficient approach that may still be optionally combined with hardware acceleration to perform the conformal operations, leading to faster and lower power solutions.

Thus, the conformal geometry based control system described herein recognizes that a desired end effector pose may be represented by a conformal geometric entity such as a circle instead of a single point. In doing so, the proposed representation of the end effector and the target object as such conformal geometric entities facilitates the simultaneously solution of both position and orientation, making it more efficient. Existing solutions attempt to approximate this behavior by generating hundreds of samples on a target circle and solving each one, only to choose the best from the sample set, which requires significant time, computation, and power consumption. For example, when grasping a cylindrical object, the conformal geometry based control system as described herein eliminates one degree of freedom (DoF). This means that the algorithm obtains the optimal solution from all valid possibilities, whereas conventional control systems need to solve the problem for a particular position and orientation, potentially requiring many iterations, to find the best position and orientation. The conformal geometry based control system described herein also mathematically converges to the best position and orientation on the target circle with minimal error.

### I. An Environment and Accompanying Control System

The control system in accordance with the aspects of the present disclosure is described with respect to a robotic arm, which may have any suitable number of movable joints. However, the aspects are not limited to the use of robotic arms, and the aspects as described herein may be implemented to control any suitable type of mechanical actuator. When a robotic arm is controlled via the control system, each joint of the robotic arm may be controlled separately via the use of generated control data, as further discussed herein, which then causes a rotation of each of the joints to form a specific angle with respect to a rotation about each joint's axis of rotation. Thus, the control system as discussed herein may facilitate a control scheme that adjusts the joint angles of a N-DoF robotic arm to reach a target pose, which is established by the orientation and position of the target object. It is noted that the pose of the robotic arm also establishes the pose of its end effector, as this is a function of the adjustment of the joint angles, and thus the pose of the end effector as discussed herein may be considered a function of the overall pose of the robotic arm. Additionally, the term “pose” as used herein may include both the position and orientation of a particular object (such as the end effector and the target object) in three-dimensional space.

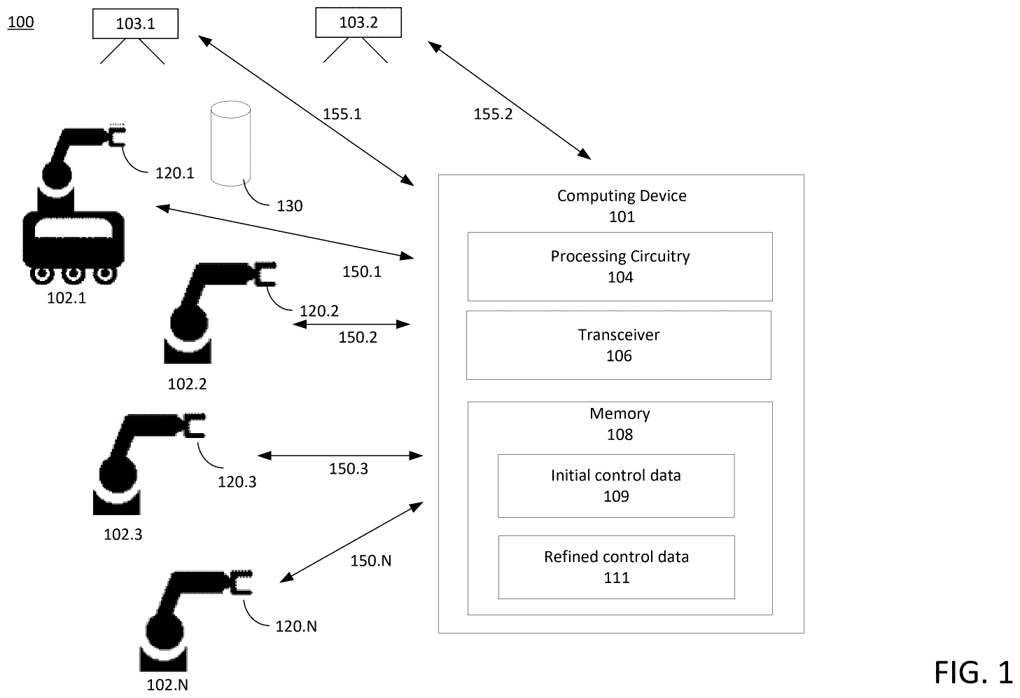

FIG. 1 illustrates a block diagram of an environment utilizing the conformal geometry based control system as described herein, which may alternatively be referred to herein simply as a control system. As shown in FIG. 1, the environment 100 supports any suitable number N of mechanical actuators 102, with four being shown for ease of explanation. The environment 100 may be any suitable type of environment that uses the mechanical actuators 102.1-102.N, such as a factory, a warehouse, etc. The mechanical actuators 102.1-102.N may have any suitable type of design configured to perform any suitable number of various tasks, as further discussed herein. Each of the mechanical actuators 102.1-102.N may be configured to communicate with other components as part of the control system as further disused below. In the non-limiting and illustrative scenario as shown in FIG. 1, the mechanical actuators 102.1-102.N may be configured as or otherwise implement respective robotic arms.

The mechanical actuators 102.1-102.N may be operated manually via receiving control data as discussed herein, or alternatively operate autonomously or semi-autonomously in response to receiving the control data. The mechanical actuators 102.1-102.N may be stationary or navigate within the environment 100 to complete specific tasks with their respective end effectors 120.1-120.N. Such tasks may be allocated to the mechanical actuators 102.1-102.N and/or identified independently by the mechanical actuators 102.1-102.N while operating within the environment 100. The mechanical actuators 102.1-102.N may be independently controlled via the control system as discussed herein, and any of the aspects as described herein with respect controlling a robotic arm may be identified with the control of a robotic arm of any of the mechanical actuators 102.1-102.N.

The mechanical actuators 102.1-102.N may include any suitable number and/or type of sensors to enable sensing of their surroundings and the generation of any suitable type of feedback. This feedback may include an angle of the joints of their mechanical arms, which may be generated via any suitable sensors integrated into the joints of the mechanical actuators 102.1-102.N, such as encoders. These sensors may additionally or alternatively include any suitable type of cameras that are integrated as part of the mechanical actuators 102.1-102.N (not shown), and thus the feedback may include images acquired via such cameras.

Additionally or alternatively, the environment 100 may include one or more cameras 103.1, 103.2, and in such a scenario the feedback may include images acquired via such cameras.

The computing device 101 is discussed in further detail below and may be implemented as any suitable type of computing device configured to function as a controller and control the movement of the robotic arms of the mechanical actuators 102.1-102.N, as discussed herein. The computing device 101 may process the feedback data received from the mechanical actuators 102.1-102.N and/or the cameras 103.1, 103.2 to identify the initial pose of the robotic arm of one of the mechanical actuators 102.1-102.N being controlled, which includes the position and orientation (e.g. the pose) of its respective end effector 120.1-120.N. The computing device 101 may also determine the position and orientation of a target object 130 (e.g. the pose) on which the respective end effector 120.1-120.N is to be used to perform a specific task, as noted herein.

To do so, the computing device 101, the mechanical actuators 102.1-102.N, and the cameras 103.1, 103.2 may be configured to communicate with one another. To do so, the computing device 101, the mechanical actuators 102.1-102.N, and the cameras 103.1, 103.2 may implement any suitable number and/or type of communication circuitry, such as wired communication circuitry and/or wireless radio components to facilitate the transmission and/or reception of any suitable type of data. This circuitry may be similar to or, for the computing device 101, identified with the transceiver 106 as shown in FIG. 1 and discussed in further detail below.

The communications between the computing device 101, the mechanical actuators 102.1-102.N, and the cameras 103.1, 103.2 may facilitate transmitting and/or receiving data via any suitable number and/or type of wired and/or wireless links, and may do so using any suitable type of communication protocols. For instance, the mechanical actuators 102.1-102.N and the computing device 101 may be configured to communicate with one another via the links 150.1-150.N to enable the computing device 101 to transmit control data to the mechanical actuators 102.1-102.N and to receive feedback data from the mechanical actuators 102.1-102.N, as discussed herein. Additionally or alternatively, the cameras 103.1, 103.2 and the computing device 101 may be configured to communicate with one another via the links 155.1, 155.2 to enable the computing device 101 to receive images from the cameras 103.1, 103.2, which additionally or alternatively may be used to compute and transmit control data to the mechanical actuators 102.1-102.N, as discussed herein.

Again, the computing device 101 may be identified with any suitable type of device that implements the conformal geometry based control system as further discussed herein, and thus may alternatively be referred to herein as a controller. The conformal geometry based control system may be executed via the computing device 101, which may form part of a robotic system in conjunction with one or more of the mechanical actuators 102.1-102.N. The computing device 101 may thus be identified with any suitable type of device such as a desktop computer, a laptop computer, a server computer, a wireless device, a user equipment (UE), a mobile phone, a tablet, a wearable device, etc. The computing device 101 may be co-located in the environment 100 with the mechanical actuators 102.1-102.N or, alternatively, the computing device 101 may be located remote from the environment 100 and the mechanical actuators 102.1-102.N. In such a latter scenario, the computing device 101 may be implemented as a remote computing device such as a server, a cloud-based computing device, etc.

The computing device 101 may comprise processing circuitry 104, which may be configured as any suitable number and/or type of computer processors, and which may function to control the computing device 101 and/or other components of the computing device 101. The processing circuitry 104 may be identified with one or more processors (or suitable portions thereof) implemented by the computing device 101. The processing circuitry 104 may be identified with one or more processors such as a host processor, a microcontroller, a digital signal processor, one or more microprocessors, a central processing unit (CPU), graphics processors such as a graphics processing unit (GPU), baseband processors, microcontrollers, an application-specific integrated circuit (ASIC), part (or the entirety of) a field-programmable gate array (FPGA), part of (or the entirety of) a system on a chip (SoC), etc.

The processing circuitry 104 may be configured to carry out instructions to perform arithmetical, logical, and/or input/output (I/O) operations, and/or to control the operation of one or more components of computing device 101 to perform various functions as described herein. The processing circuitry 104 may include one or more microprocessor cores, memory registers, buffers, clocks, etc., and may generate electronic control signals associated with the components of the computing device 101 to control and/or modify the operation of these components. The processing circuitry 104 may communicate with and/or control functions associated with the memory 108, as well as any other components of the computing device 101. Thus, the processing circuitry 104 may control or cause other components to control the mechanical actuators 102.1-102.N in accordance with a differential kinematics control scheme, as discussed herein.

The transceiver 106 may be implemented as any suitable number and/or type of components configured to transmit and/or receive data and/or wireless signals in accordance with any suitable number and/or type of communication protocols. The transceiver 106 may include any suitable type of components to facilitate this functionality, including components associated with known transceiver, transmitter, and/or receiver operation, configurations, and implementations. Although depicted in FIG. 1 as a transceiver, the transceiver 106 may include any suitable number of transmitters, receivers, or combinations of these that may be integrated into a single transceiver or as multiple transceivers or transceiver modules. The transceiver 106 may include components typically identified with an RF front end and include antennas, ports, power amplifiers (PAS), RF filters, mixers, local oscillators (LOs), low noise amplifiers (LNAs), upconverters, downconverters, channel tuners, etc. Thus, the transceiver 106 may be configured as any suitable number and/or type of components configured to facilitate receiving and/or transmitting data and/or signals in accordance with one or more communication protocols. The transceiver 106 may be implemented as any suitable number and/or type of components to support wireless communications such as analog-to-digital converters (ADCs), digital to analog converters (DACs), intermediate frequency (IF) amplifiers and/or filters, modulators, demodulators, baseband processors, etc.

The memory 108 is configured to store data and/or instructions such that, when executed by the processing circuitry 104, cause the electronic device 101 to perform various functions such as monitoring and/or controlling any of the mechanical actuators 102.1-102.N in accordance with a conformal geometry based control system that provides a differential kinematics control scheme, as discussed in further detail herein. The memory 108 may be implemented as any suitable type of volatile and/or non-volatile memory, including read-only memory (ROM), random access memory (RAM), flash memory, a magnetic storage media, an optical disc, erasable programmable read only memory (EPROM), programmable read only memory (PROM), etc.

The memory 108 may be non-removable, removable, or a combination of both. The memory 108 may be implemented as a non-transitory computer readable medium storing one or more executable instructions such as logic, algorithms, code, etc. The instructions, logic, code, etc., stored in the memory 108 are represented by the various modules as shown. The processing circuitry 104 may execute the instructions stored in the memory 108, which are represented as the various modules and further discussed below, to enable any of the techniques as described herein to be functionally realized.

The initial control data module 109 may store computer-readable instructions that, when executed by the processing circuitry 104, enable the processing circuitry 104 to generate an initial set of control data, which may then be transmitted to the any of the mechanical actuators 102.1-102.N to control a robotic arm thereof. As further discussed herein, the initial set of control data may cause each of the joints of the robotic arm to be adjusted to a specific calculated angle to cause the end effector to have a desired pose.

The refined control data module 109 may store computer-readable instructions that, when executed by the processing circuitry 104, enable the processing circuitry 104 to modify the initial set of control data and to generate a revised set of control data. The revised set of control data may further adjust the angles of the joints of the robotic arm from their initial adjustment by way of the initial set of control data. Thus, and as further discussed herein, the initial set of control data may cause the robotic arm of one of the mechanical actuators 102.1-102.N to move to a new pose by adjusting the angle of one of the joints. Then, the revised set of control data may be generated based on the feedback received with respect to the angle at each joint of the robotic arm upon the robotic arm being moved to that new pose. As a result, the revised set of control data may function to correct the adjustment of the angles formed by each of the joints of the robotic arm based upon feedback received from the mechanical actuators 102.1-102.N, a camera on the robotic arm, the cameras 103.1, 103.2, etc.

### II. Defining Conformal Geometric Entities for Differential Kinematics Control

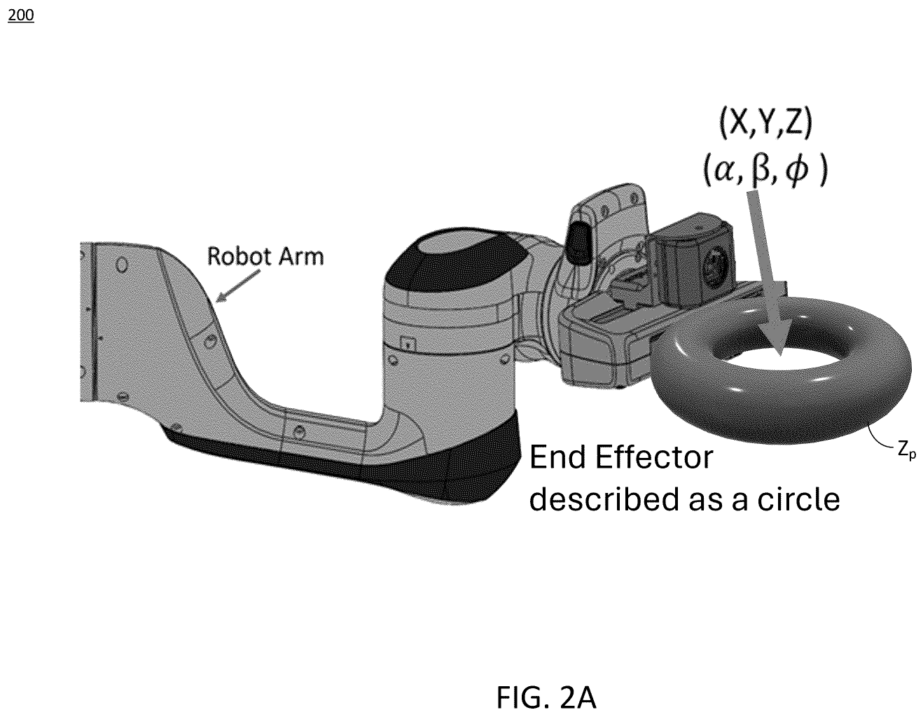

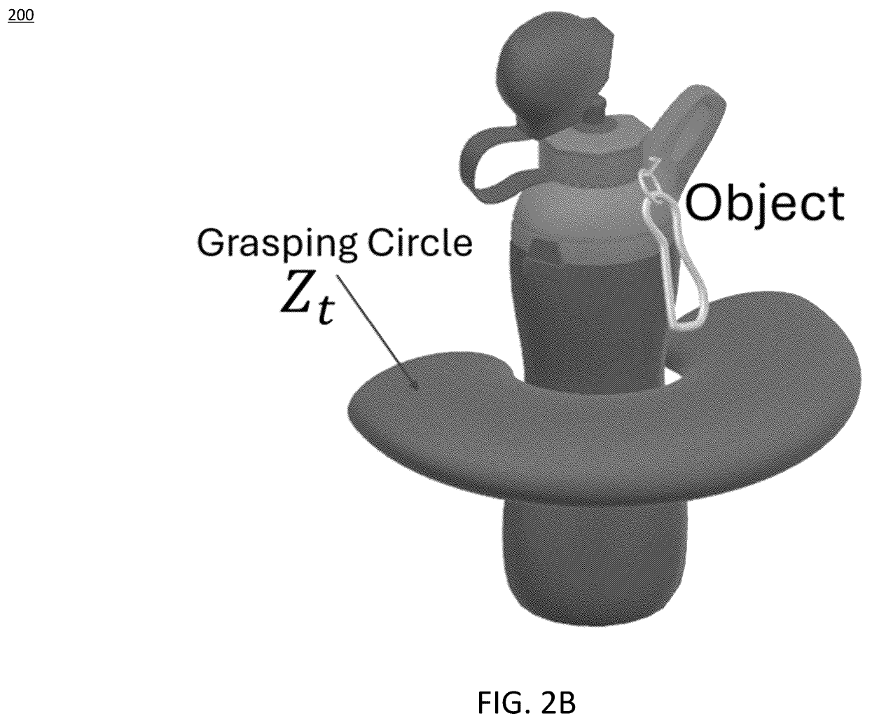

FIGS. 2A and 2B illustrate the modeling of an end effector and a target object as conformal geometric entities in accordance with the control system of the disclosure. The control system as discussed herein functions to generate control data that adjusts the joint angles of the robotic arm, and in doing so guides the end effector to the target object in accordance with a specific pose to enable a particular task to be performed. Thus, it is noted that conventional algorithms perform visually guided grasping to control the position and the orientation of the end effector independently of one another. However, by using a single conformal geometric primitive (i.e. conformal geometric entity such as a circle) to model the end effector and the target object, the position and the orientation of the end-effector and the target object may be considered simultaneously. Such a geometric primitive is efficiently represented by a bivector of Conformal Geometric Algebra (CGA). Additional details are now provided with respect to an illustrative scenario in which CGA is implemented as part of a control system to model the kinematics and differential kinematics of a 7Dof robotic arm, and to express the differential kinematics of the end effector circle. In this way, a control scheme is implemented that is based on differential kinematics of circles to guide the robotic arm to reach a desired target pose.

Thus, and as referenced in further detail below, the end effector of a robotic arm, which may be identified with one of the end effectors 120.1-120.N, is shown in FIG. 2A as a conformal geometric entity comprising a first circle Zₚ, whereas the target object is shown in FIG. 2B as a conformal geometric entity comprising a second circle Zₜ. It is noted that for both FIGS. 2A and 2B, the end effector circle Zₚ and the target object circle Zₜ are shown having a three-dimensional torus shape. However, it is noted that this depiction is provided for ease of explanation, and both the end effector circle Zₚ and the target object circle Zₜ may be understood as representing conformal geometric entities as defined in accordance with known CGA definitions, and essentially comprise a “wireframe” of a circle in each case that occupies a single plane.

Thus, and as discussed in further detail herein, the control system implemented by the computing device 101 may generate control data to adjust respective angles of the one or more movable joints of the particular robotic arm that is being controlled. This control data (Which may include the initial and revised control data as discussed herein), aims to adjust the pose of the robotic arm to direct the center of the effector circle Zₚ to coincide with a center of the target object circle Zₜ. In this way, the control data functions to guide the end effector to reach a target position and orientation that is aligned with the target object based upon the particular task to be performed. However, the use of the conformal geometric entity modeling as described herein allows for this solution to be computed more efficiently, with more accuracy (due to the revision of the control data), and with less computations.

Thus, it is prudent to provide additional detail regarding the various definitions provided in the field of CGA. To this end, it is first noted that Geometric algebra G_{4,1} can be used to express conformal geometry in an efficient way. For instance, the same formulation is used to show how the Euclidean vector space [symbol] is represented in [symbol] . This space has an orthonormal vector basis given by {e₁, e₂, e₃, e₄, e₅} with the properties of the Clifford product in Table 1.

TABLE 1
the Clifford Product

| Basis | e₁ | e₂ | e₃ | e₄ | e₅ |
|---|---|---|---|---|---|
| e₁ | 1 | e₁₂ | −e₃₁ | e₁₄ | e₁₅ |
| e₂ | −e₁₂ | 1 | e₂₃ | e₂₄ | e₂₅ |
| e₃ | e₃₁ | −e₂₃ | 1 | e₃₄ | e₃₅ |
| e₄ | e₄₁ | e₄₂ | e₄₃ | 1 | E |
| e₅ | e₅₁ | e₅₂ | e₅₃ | −E | −1 |

With respect to Table 1, eᵢⱼ=eᵢ∧eⱼ are the bivectorial basis, and therefore e₂₃, e₃₁ and e₁₂ are the Hamilton basis. A unit Euclidean pseudo-scalar Iₑ, a pseudo-scalar I_{c}, and the bivector E defined as:

$${I}_{e} := {e}_{1} ∧ {e}_{2} ∧ {e}_{3} , \qquad Eqn . 1$$

$$E := {e}_{4} ∧ {e}_{5} = {e}_{4} {e}_{5} , \qquad Eqn . 2$$

$${I}_{c} := {I}_{e} ∧ E = {I}_{e} E \qquad Eqn . 3$$

A representation of conformal geometric entities in accordance with CGA is also shown below in Table 2.

TABLE 2

| Entity | Representation | Dual representation |
|---|---|---|
| Sphere | $s = p - \frac{1}{2} {ρ}^{2} {e}_{∞}$ | s* = x₁ ∧ x₂ ∧ x₃ ∧ x₄ |
| Point | ${x}_{c} = {x}_{e} + \frac{1}{2} {x}_{e}^{2} {e}_{∞} + {e}_{0}$ | x* = s₁ ∧ s₂ ∧ s₃ ∧ s₄ |
| Line | L = π₁ ∧ π₂ | L* = x₁ ∧ x₂ ∧ e_{∞} |
| Plane | π = n + de_{∞} | π* = x₁ ∧ x₂ ∧ x₃ ∧ e_{∞} |
| Circle | z = s₁ ∧ s₂ | z* = x₁ ∧ x₂ ∧ x₃ |
| Pair of P. | Pₚ = s₁ ∧ s₂ ∧ s₃ | Pₚ* = x₁ ∧ x₂ |

### III. Differential Kinematics of Circles in Conformal Geometric Algebra (CGA)

In conformal geometric algebra, the forward kinematics of the end-effector circle is given by:

$${z}_{p}^{′} = {\prod }_{i = 1}^{n} {M}_{i} {z}_{p} {\prod }_{i = 1}^{n} {\tilde{M}}_{n - i + 1} \qquad Eqn . 4$$

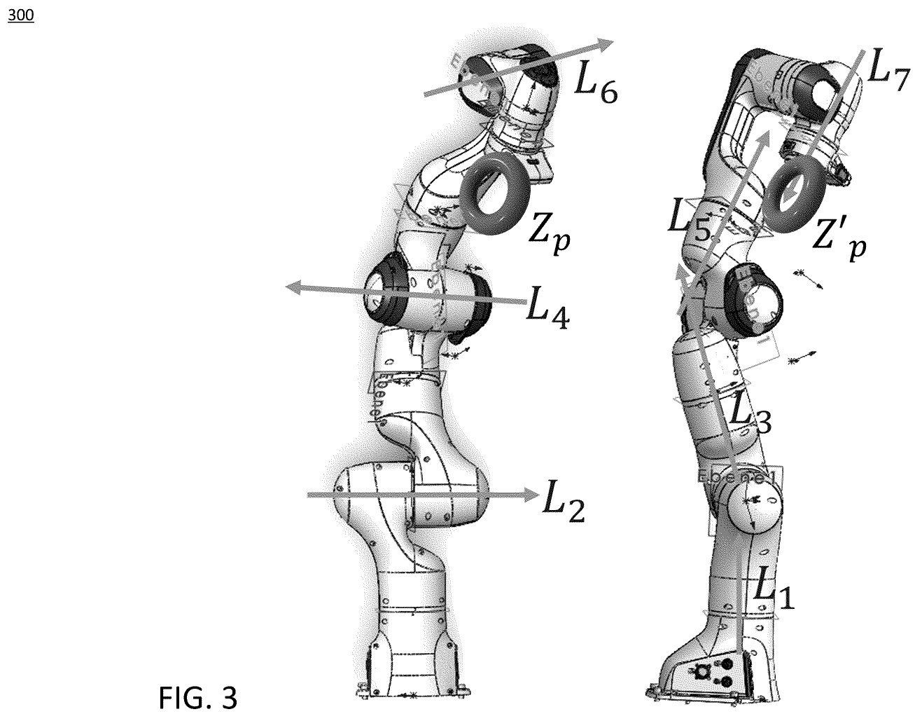

With reference to Eqn. 4, the term zₚ represents the end effector modeled as a conformal geometric entity comprising a circle, as noted above with respect to FIG. 2A, using the notation as shown in Table 2. The term M represents a motor operator in accordance with motor algebra, which performs a 3D rigid transformation with respect to the end effector circle zₚ. Thus, the term zₚ′ thus represents the forward kinematics of the end effector when modeled as the conformal geometric entity of the circle zₚ. The index i is used to define the number of movable joints of the robotic arm that is being controlled, which corresponds to its degrees of freedom. This is illustrated in further detail in FIG. 3, which shows two views of a robotic arm being controlled via the control system as described herein. Thus, and as shown in FIG. 3, end effector circle zₚ is shown, which corresponds to the conformal geometric representation of the end effector prior to its motor transformation (the left side of FIG. 3), whereas zₚ′ represents the pose of the conformal geometric representation of the end effector after the motor operator transformation (the right side of FIG. 3). To implement the use of conformal geometry as part of the control system, the axis corresponding to each joint of the robotic arm, about which each joint rotates to form a respective angle as discussed herein, is represented in the forward kinematics solution by respective lines Lᵢ, with each line being provided as a bivector of conformal geometry (See Table 1).

From Eqn. 4, an expression may be obtained for differential kinematics through the total differentiation of Eqn. 4 as follows:

$${dz}_{p}^{′} = {\sum }_{j = 1}^{n} {\partial }_{{q}_{j}} ( {\prod }_{i = 1}^{n} {M}_{i} {z}_{p} {\prod }_{i = 1}^{n} {\tilde{M}}_{n - i + 1} ) {dq}_{j} \qquad Eqn . 5$$

With respect to Eqn. 5, the term q is now introduced, which represents the angle at each joint of the robotic arm as noted above. Additionally, each term of the sum is the product of two functions in qⱼ, and thus the differential yields:

$${dz}_{p}^{′} = {\sum }_{j = 1}^{n} [ {\partial }_{{q}_{j}} ( {\prod }_{i = 1}^{j} {M}_{i} ) {\prod }_{i = j + 1}^{n} {M}_{i} {z}_{p} {\prod }_{i = 1}^{n} {\tilde{M}}_{n - i + 1} + {\prod }_{i = 1}^{n} {M}_{i} {z}_{p} {\prod }_{i = 1}^{n - j} {\tilde{M}}_{n - i + 1} {\partial }_{{q}_{j}} ( {\prod }_{i = n - j + 1}^{n} {\tilde{M}}_{n - i + 1} ) ] {dq}_{j} \qquad Eqn . 6$$

And because

$$M = {e}^{- \frac{1}{2} q L} ,$$

the differential of the motor

$$d ( M ) = - \frac{1}{2} MLdq .$$

Thus, the partial differential of the motor's product may be represented as follows:

$${\partial }_{{q}_{j}} ( {\prod }_{i = 1}^{j} {M}_{i} ) = - \frac{1}{2} {\prod }_{i = 1}^{j} {M}_{i} {L}_{j} = - \frac{1}{2} ( {\prod }_{i = 1}^{j - 1} {M}_{i} ) {L}_{j} {M}_{j} \qquad Eqn . 7$$

Similarly, the differential of the term

$$\tilde{M} = {e}^{\frac{1}{2} q L} yields d ( \tilde{M} ) = \frac{1}{2} MLdq ,$$

and the differential of the product is thus represented as:

$${\partial }_{{q}_{j}} ( {\prod }_{i = n - j + 1}^{n} {\tilde{M}}_{n - i + 1} ) = \frac{1}{2} {\tilde{M}}_{j} {L}_{j} {\prod }_{i = n - j + 2}^{n} {\tilde{M}}_{n - i + 1} \qquad Eqn . 8$$

By replacing Equations 7 and 8 in Equation 6 thus yields:

$${dz}_{p}^{′} = - \frac{1}{2} {\sum }_{j = 1}^{n} [ {\prod }_{i = 1}^{j - 1} {M}_{i} ( {L}_{j} ( {\prod }_{i = j}^{n} {M}_{i} {z}_{p} {\prod }_{i = 1}^{n - j + 1} {\tilde{M}}_{n - i + 1} ) - ( {\prod }_{i = j}^{n} {M}_{i} {z}_{p} {\prod }_{i = 1}^{n - j + 1} {\tilde{M}}_{n - i + 1} ) {L}_{j} ) {\prod }_{i = 1}^{j - 1} {\tilde{M}}_{j - 1} ] {dq}_{j} \qquad Eqn . 9$$

By definition, the product “∘” of two bivectors is given by:

$$A ∘ B = AB - BA \qquad Eqn . 10$$

Thus, using Eqn. 10, Eqn. 9 may be simplified, since L and Zₚ are bivectors, and Equation 9 may be rewritten as follows:

$${dz}_{p}^{′} = {\sum }_{j = 1}^{n} [ ( {\prod }_{i = 1}^{j - 1} {M}_{i} ) ( ( {\prod }_{i = j}^{n} {M}_{i} {z}_{p} {\prod }_{i = 1}^{n - j + 1} {\tilde{M}}_{n - i + 1} ) ∘ {L}_{j} ) {\prod }_{i = 1}^{j - 1} {\tilde{M}}_{j - i} ] {dq}_{j} \qquad Eqn . 11$$

The product of i=[1,j−1] and i=[j,n] is equal to the product of i=[1,n]. Also, for \tilde{M}, Eqn. 11 may be written as:

$${dz}_{p}^{′} = {\sum }_{j = 1}^{n} [ ( {\prod }_{i = 1}^{n} {M}_{i} {z}_{p} {\prod }_{i = 1}^{n} {\tilde{M}}_{n - i + 1} ) ∘ ( {\prod }_{i = 1}^{j - 1} {M}_{i} {L}_{j} {\prod }_{i = 1}^{j - 1} {\tilde{M}}_{j - i} ) ] {dq}_{j} \qquad Eqn . 12$$

Using the equation of the direct kinematics from Eqn. 4, Eqn. 12 may be simplified as follows:

$$d {z}_{p}^{′} = {\sum }_{j = 1}^{n} [ {z}_{p}^{′} ∘ ( {\prod }_{i = 1}^{j - 1} {M}_{i} {L}_{j} {\prod }_{i = 1}^{j - 1} {\tilde{M}}_{j - i} ) ] {dq}_{j} \qquad Eqn . 13$$

The equation of forward kinematics of circles in CGA also applies for lines i, and thus Eqn. 4 may be used to define the transformed line L′ in terms of L as follows:

$${L}_{j}^{′} = {\prod }_{i = 1}^{j - 1} {M}_{i} {L}_{j} {\prod }_{i = 1}^{j - 1} {\tilde{M}}_{j - i} \qquad Eqn . 14$$

This yields a very compact expression of differential kinematics as:

$$d {z}_{p}^{′} = {\sum }_{j = 1}^{n} [ {z}_{p}^{′} ∘ {L}_{j}^{′} ] {dq}_{j} \qquad Eqn . 15$$

Thus, and with respect to Eqn. 15, dzₚ′ represents a contribution of the motion of all joints of the robotic arm to move the end effector circle to a target pose to align with the target object circle, each being modeled as a conformal geometric entity as discussed herein. Again, this alignment may comprise the center of the end effector circle coinciding with the center of the target object circle. In other words, the computing device 101 may calculate the initial set of control data by evaluating Eqn. 15 based upon an initial orientation and position of the end effector and the target object in three-dimensional space, with each being modeled as a conformal geometric entity comprising a circle.

Thus, dzₚ′ may represent a differential kinematics motion solution of the conformal geometric representation of the end effector circle, which is represented in Eqn. 15 as zₚ′. This solution includes a summation of movement of all joints in the robotic arm to move the end effector circle to a pose that results in the center of the end effector circle coinciding with the center of the target object circle. That is, j represents an index of a number of the one or more movable joints n of the robotic arm, Lⱼ′ represents a transformed line in terms of an axis of rotation of each respective one of the one or more movable joints n of the robotic arm, and dqⱼ represents a differential that indicates how an angle qⱼ of each one of the movable joints n of the robotic arm changes to result in the center of the end effector circle coinciding with the center of the target circle. This summation thus includes, for each joint angle qⱼ, a multiplication of the change in the joint angle dqⱼ by a respective product of two bivectors, with one bivector being identified with the end effector circle zₚ′, and the other bivector being identified with the transformed line Lⱼ′ of the respective joint.

In this way, Eqn. 15 represents a differential kinematics motion solution in which the right hand side describes changes in the joint angles of the robotic arm, and the left hand side describes how the end effector circle pose changes in three-dimensional space due to changes in the joint angles. Eqn. 15 allows the computing device 101 to determine the set of joint angles formed at each of the joints of the robotic arm that, when actuated, result in the center of the end effector circle coinciding with the center of the target object circle. Thus, the processing circuitry 104 may execute the instructions stored in initial control data module to generate the initial set of control data by evaluating Eqn. 15 in accordance with an initial pose of the end effector circle and the target circle in three-dimensional space.

Once Eqn. 15 is evaluated to determine the set of joint angles for the robotic arm in this manner, the computing device 101 may then generate the initial set of control data by translating this set of joint angles into suitable commands that are transmitted to the mechanical actuator 102.1-102.N that is currently being controlled. This results in the robotic arm moving to a new position that aims to align the center of the end effector circle with the center of the target circle to coincide with one another. In other words, the initial set of control data aims to move the end effector circle to have the same center as that of the target object circle. And because the end effector and target object are modeled as conformal geometric entities such as circles, the evaluation of Eqn. 15 in this manner enables a simultaneous alignment of the position and orientation of the end effector circle and the target circle with one another.

Thus, the computing device 101 may determine the initial pose of the end effector and the target object for the robotic arm that is being controlled using any suitable techniques. In some non-limiting and illustrative scenarios, the computing device 101 may receive encoder data from the robotic arm that indicates the current angle of each of the robotic arm's joints. The computing device 101 may also receive or otherwise have access to location information regarding the position and orientation of the robotic arm within the environment 100. Such information may be received via the mechanical actuator 102.1-102.N or, alternatively, may represent predetermined information for a mechanical actuator that is stationary. The computing device 101 may then combine the location information with the encoder data to derive the pose of the end effector in three-dimensional space, which may be used to model the end effector as a conformal geometric entity comprising a circle, as discussed herein.

As another non-limiting and illustrative scenario, the computing device 101 may receive images of the robotic arm being controlled via one or more cameras within the environment 100, such as the cameras 103.1, 103.2. Additionally or alternatively, the robotic arm may have a camera disposed thereon, such as near the end effector 120 (not shown). Thus, the computing device 101 may utilize any combination of images acquired from the robotic arm camera(s) and/or the cameras 103.1, 103.2 to determine the pose of the target object in three-dimensional space, which may be used to model the target object as a conformal geometric entity comprising a circle, as discussed herein.

### V. Kinematic Control and Error Reduction

As noted above, Eqn. 15 may be evaluated to compute the initial set of control data that leverages a differential kinematic solution to attempt to move the end effector circle such that its center coincides with that of the target object circle. This Section describes the use of an additional robotic kinematics control, which may be implemented in conjunction with the initial set of control data as described above to provide an overall control scheme. The techniques described in this Section aim to minimize or at least reduce error in the initial set of control data. Thus, the techniques described in this Section may be implemented via the processing circuitry 104 executing instructions stored in the refined control data module 111 to modify the initial set of control data and thereby generate a revised set of control data to control the robotic arm and guide the end effector circle to the target circle, as discussed herein. The revised set of control data, when translated and transmitted to the robotic arm, further adjusts the joint angles of the movable joints in accordance a loss function, which were previously moved to their current angles by way of the initial set of control data. Additionally, the control scheme as discussed herein may generate the revised set of control data by minimizing a defined loss function using any suitable techniques, which may include the use of a gradient descent process. Thus, the revised set of control data may represent updated joint angles, which include a “delta” angle value between the current angle of each joint and a target angle that functions to minimize or at least reduce the error between the center point of the end effector and target object circles coinciding with one another, as further discussed herein.

The control scheme as discussed in this Section is first defined based on the orientation of the end effector and then based on its position to yield a single control scheme that simultaneously considers the position and orientation of the end effector (i.e. its pose). Again, this kinematic control may be formulated as a loss function, which advantageously allows for optimization techniques to be leveraged, such as gradient descent, to adjust the initial joint angles q. In this way, the revised set of control data functions to adjust the values of q as established via the initial set of control data to minimize (or at least reduce) the error. Again, the error may be defined as a difference between the end-effector pose and the target pose, which results in the centers of the end effector circle and the target circle not coinciding with one another. As noted herein, the term “pose” includes both position and orientation, and thus the error is expressed with respect to a difference between the end effector and target circle poses, as the joints angles are adjusted to reduce the error of the position and orientations simultaneously. The error may thus be based upon any suitable type of feedback that allows for a determination of the identified position and orientation of the end effector circle and the target circle after moving the robotic arm in accordance with the initial set of control data. Again, this feedback may represent encoder data from the joints of the robotic arm, camera images from robotic arm-mounted cameras and/or environmental cameras such as the cameras 103.1, 103.2, etc.

The error, which may be defined in accordance with a loss function, may thus be represented as follows:

$${E}_{o} = \frac{1}{2} {( {Z}_{t} - {Z}_{p} )}^{2} \qquad Eqn . 16$$

With respect to Eqn. 16, E, represents the error, Zₜ once again represents the target object circle as a conformal geometric entity, and Zₚ represents the end effector circle, which describes the pose of the robot arm defined by the angles between the joints q. This relates to the direct kinematics equation given by Eqn. 4 above. Therefore, Eqn. 16 may represent the error with respect to a difference between the pose of the end effector and target object circles after the robotic arm is moved in accordance with the initial set of control data. Again, the position and orientation of the end effector and target object circles may be determined using any suitable feedback, such as encoder data from the robotic arm joints, acquired images from cameras on the robotic are and/or in the environment 100 (such as the cameras 103.1, 103.2). Thus, to adjust the joint angles q to minimize the error Eₒ, the partial derivative is computed as:

$$\frac{\partial {E}_{o}}{\partial {q}_{i}} = - ( {Z}_{t} - {Z}_{p} ) \frac{\partial {Z}_{p}}{\partial {q}_{i}} \qquad Eqn . 17$$

Again, in the previous Section, Eqn. 15 described the differential kinematics

$$\frac{\partial {Z}_{p}}{\partial {q}_{i}}$$

in terms of rotation axis Lᵢ, and thus Eqn. 17 may be rewritten as follows:

$$\frac{\partial {E}_{o}}{\partial {q}_{i}} = - ( {Z}_{t} - {Z}_{p} ) \cdot [ {Z}_{p} ∘ {L}_{i}^{′} ] \qquad Eqn . 18$$

In other words, a partial derivative of the error is taken with respect to the angles between joints, which aims to minimize of the error as a function of the changes in the joint angles. Again, this minimization may be performed via a gradient descent process, including known techniques to do so. As one non-limiting and illustrative scenario, the refined set of control data may be generated as discussed herein in accordance with a minimum seeking control, in which the adjusted joint angles are determined to be proportional to a gradient of the error.

To create a control scheme for the position of the end-effector, the error given by the difference between the position of the end effector circle and the target circle may be computed in accordance with Eqn. 19 below as follows:

$${E}_{p} = \frac{1}{2} {( {P}_{t} - {X}_{p} )}^{2} \qquad Eqn . 19$$

With respect to Eqn. 19, Pₜ represents the target position of the target object (i.e. the target circle) and Xₚ represents the position of the end effector (the end effector circle). Thus, Xₚ also represents the center of the end effector circle and may thus be replaced by a conformal geometric entity comprising a sphere Sₚ having a center in the center of the end effector circle, which is represented as:

$${S}_{p} = {Z}_{p} / {π}_{p} \qquad Eqn . 20$$

With respect to Eqn. 20, πₚ represents a plane of the end effector circle given by πₚ*=Zₚ*∧e_{∞}. Then, the error may be rewritten as:

$${E}_{p} = \frac{1}{2} {( {P}_{t} - {S}_{p} )}^{2} \qquad Eqn . 21$$

The minimization of the error Eₚ as a result of adjusting the joint angles q may now be written as:

$$\frac{\partial {E}_{p}}{\partial {q}_{i}} = - ( {P}_{t} - {S}_{p} ) \frac{\partial {s}_{p}}{\partial {q}_{i}} \qquad Eqn . 22$$

The differential kinematics of points and spheres are computed using [Sₚ·L′ᵢ], and therefore Eq. 22 may be simplified as:

$$\frac{\partial {E}_{p}}{\partial {q}_{i}} = - ( {P}_{t} - {S}_{p} ) \cdot [ {Z}_{p} {π}_{p}^{- 1} \cdot {L}_{i}^{′} ] \qquad Eqn . 23$$

Additionally, Eqns. 17 and 23 may be merged because these are bivectors and vectors, respectively, and this merge represents a weighted sum by adding the control gains no and np, which provide the gain of the control scheme as follows:

$$\frac{{η}_{p} \partial {E}_{p}}{\partial {q}_{i}} + \frac{{η}_{o} \partial {E}_{o}}{\partial {q}_{i}} = - {η}_{p} ( {P}_{t} - {S}_{p} ) \cdot [ {Z}_{p} {π}_{p}^{- 1} \cdot {L}_{i}^{′} ] - {η}_{o} ( {Z}_{t} - {Z}_{p} ) \cdot [ {Z}_{p} ∘ {L}_{i}^{′} ]$$

Furthermore, by regrouping the terms:

$$\frac{{η}_{p} \partial {E}_{p}}{\partial {q}_{i}} + \frac{{η}_{o} \partial {E}_{o}}{\partial {q}_{i}} = - ( {η}_{p} ( {P}_{t} - {S}_{p} ) + {η}_{o} ( {Z}_{t} - {Z}_{p} ) ) \cdot [ {Z}_{p} ( {π}_{p}^{- 1} + 1 ] {L}_{i}^{′} ]$$

Then, the control scheme to update the joint angles is given by:

$$Δ {q}_{i} = ( {η}_{p} ( {P}_{t} - {S}_{p} ) + {η}_{0} ( {Z}_{t} - {Z}_{p} ) ) \cdot [ {Z}_{p} ( {π}_{p}^{- 1} + 1 ) {L}_{i}^{′} ] \qquad Eqn . 24$$

It is noted that the control gains of ηₒ and ηₚ may be considered analogous to learning rates used in accordance with neural networks. Thus, the control gains may be established using any suitable techniques, including known techniques and/or those typically defined in accordance with machine learning. With respect to Eqn. 24, Sₚ=Zₚπₚ⁻¹, Sₜ=Zₜπₜ⁻¹, and Pₜ represents a center of the sphere Sₜ, which allows Eqn. 24 to be represented in terms of circles. Thus, Eqn. 24 represents a control law or scheme that is evaluated by the computing device (such as via the processing circuitry 104 executing the instructions stored in the refined control data module 111) to reduce the error, which is defined as the difference between the poses of the end effector and target object circles. With respect to Eqn. 24, the left hand side term Δqᵢ represents how the joint angles change between successive states, i.e. a “delta” between a future joint angle and the current joint angle. It is noted that this is a function of the error between the end effector and target object circles, as discussed above. Therefore, the computing device 101 may evaluate Eqn. 24 upon identifying the pose of the end effector and target object circles to determine the error as the difference between their poses and, in response, compute the future joint angle as a function of the minimization of this error.

Thus, the minimization of the error in this way functions to ensure that the center of the end effector and target object circles coincide with one another with respect to any suitable acceptable distance threshold condition being satisfied. Thus, the computing device 101 may iteratively evaluate Eqn. 25 as part of the generation of the revised set of control data until the error is determined to be minimized or, alternatively, the threshold condition is satisfied. In other words, although the computing device 101 may aim to minimize the error between the centers of the end effector and target object circles coinciding with one another, for some applications this minimization is not strictly necessary, and thus the computing device 101 may stop the iterative process of generating the revised set of control data when the distance threshold condition between the centers of the end effector and target object circles is reached, despite this not necessarily minimizing the error. Such aspects may be particularly useful when a known amount of error is acceptable, which may be based upon the particular task and application.

Thus, the initial set of control data as discussed with respect to Eqn. 15 may represent the collection of all joint angles of the robotic arm that is to be controlled, which aims to move the end effector circle such that its center coincides with that of the target object circle. The revised set of control data may then be generated in an iterative manner in accordance with Eqn. 24, which aims to minimize the error by way of the use of the loss function as shown in Eqn. 16. In this way, the computing device 101 may generate the revised set of control data in an iterative manner by evaluating Eqn. 24 on a joint-by-joint basis until the error is minimized or at least reduced. As a result, when the computing device 101 translates the revised set of control data to a set of joint angles, it is ensured that the robotic arm is guided to the target object in an efficient and accurate manner.

### V. A Process Flow

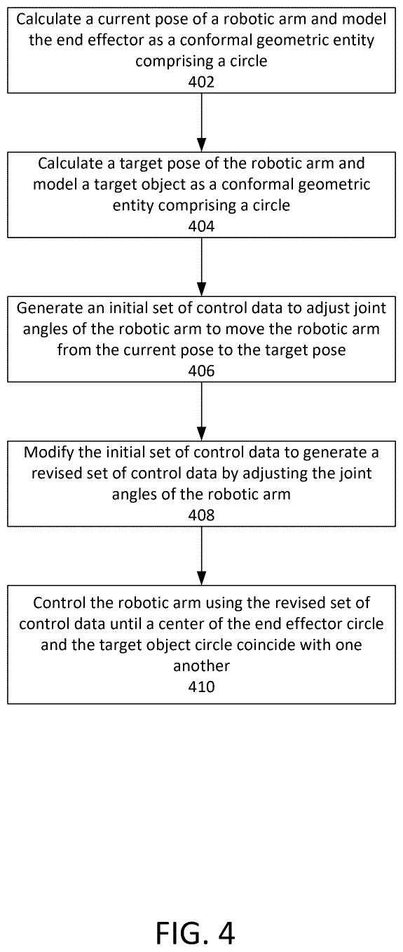

FIG. 4 illustrates a process flow, in accordance with the present disclosure. With reference to FIG. 4 the flow 400 may be a manual process, a fully-automated process, or a partially-automated process. When fully or partially-automated, any portion or the entirety of the flow 400 may be implemented as a computer-implemented process executed by and/or otherwise associated with one or more processors. These processors may be associated with one or more computing components identified with any suitable computing device, such as a computing device or manufacturing component configured to perform such functionality. This computing device may be identified, in some non-limiting and illustrative scenarios, with the computing device 101 as discussed herein. Thus, in accordance with such scenarios, the processing circuitry 104 may execute instructions stored in the memory 108 to perform any portion of the process flow 400. The process flow 400 may include alternate or additional steps that are not shown in FIG. 4 for purposes of brevity, and may be performed in a different order than the steps shown in FIG. 4.

Flow 400 may begin by calculating (block 402) a current pose of the robotic arm as discussed herein, which may be calculated based upon any suitable type of feedback data regarding location of the robotic arm, the angles of the joints, the shape and position of the end effector, etc. Again, such feedback data may include encoder data and/or images of the robotic arm and end effector, as discussed herein. The calculation of the current pose of the robotic arm may also include calculating (block 402) the initial position and orientation of the end effector. The calculation (block 402) of the current pose of the robotic arm may also include modeling the end effector as a conformal geometric entity comprising a circle, which may have a center that is aligned with a geometry of the end effector once the position and orientation of the end effector is calculated.

Flow 400 may include calculating (block 404) a target pose of the robotic arm as discussed herein, which may be calculated based upon any suitable type of feedback data regarding location of the target object. Again, such feedback data may include images of the target object, as discussed herein. The calculation of the target pose of the robotic arm may also include calculating (block 404) the position and orientation of the target object and a corresponding target pose such that the center of the end effector circle coincides with the center of the target object circle, as discussed herein. Thus, the calculation (block 404) of the target pose of the robotic arm may also include modeling the target object as a conformal geometric entity comprising a circle, which may have a center that is aligned with a geometry of the target object once the position and orientation of the target object is calculated.

The flow 400 may further comprise generating (block 406) an initial set of control data to control the robotic arm to adjust the joint angles, and thus move the robotic arm from the current pose to the target pose. This may include the computing device 101 generating the initial set of control data via the evaluation of Equation 15, as discussed above.

The flow 400 may further comprise modifying (block 408) the initial set of control data to generate a revised set of control data by adjusting the joint angles of the robotic arm. This may include, for instance, the computing device 101 further adjusting the joint angles from those calculated in the initial set of control data in accordance with the minimization of a loss function, as discussed herein with respect to Equations 16 and 24.

The flow 400 may further comprise controlling (block 410) the robotic arm using the revised set of control data to further adjust the joint angles of the robotic arm. This may include, for instance, the computing device 101 translating the revised set of control data to suitable joint control commands, which are then transmitted to the robotic arm. In response, the robotic arm joint angles are further adjusted to direct the end effector circle to the target object circle until the center of the end effector circle coincides with the target object circle, as discussed herein.

It is understood that, in this context, the end effector circle and the target object circle may coincide with one another via control of the joint angles using the initial set of control data as well as the revised set of control data. That is, in each case the center of each circle may be determined to coincide with one another with respect to any suitable acceptable distance threshold condition being satisfied. However, it will be understood that the revised set of control data may improve upon the accuracy of the end effector circle and the target object circle coinciding with one another, and thus the centers of both circles may be brought closer together by way of the minimization of the loss function, as noted herein.

### VI. General Operation of a Computing Device

A computing device is provided. The computing device comprises a memory configured to store computer-readable instructions; and processing circuitry configured to execute the computer-readable instructions to cause the computing device to: calculate a current pose of a robotic arm comprising one or more movable joints and an end effector that is modeled as a first conformal geometric entity comprising a first circle; calculate a target pose of the robotic arm to be positioned to perform a task with respect to a target object that is modeled as a second conformal geometric entity comprising a second circle; and control the robotic arm to move from the current pose to the target pose by adjusting respective joint angles of the one or more movable joints to direct a center of the first circle to coincide with a center of the second circle. In addition or in alternative to and in any combination with the optional features previously explained in this paragraph, the processing circuitry is configured to execute the computer-readable instructions to control the robotic arm to move from the current pose to the target pose using differential kinematics. In addition or in alternative to and in any combination with the optional features previously explained in this paragraph, the processing circuitry is configured to execute the computer-readable instructions to control the robotic arm to move from the current pose to the target pose by simultaneously computing a position and orientation of the first circle and the second circle. In addition or in alternative to and in any combination with the optional features previously explained in this paragraph, the processing circuitry is configured to execute the computer-readable instructions to control the robotic arm using an initial set of control data that indicates each of the respective joint angles of the one or more movable joints. In addition or in alternative to and in any combination with the optional features previously explained in this paragraph, the processing circuitry is configured to execute the computer-readable instructions to control the robotic arm by generating an initial set of control data by evaluating: dzₚ′=Σⱼ₌₁ⁿ[zₚ′∘Lⱼ′]dqⱼ,zₚ′ represents a conformal geometric representation of the first circle, dzₚ′ represents a differential kinematics motion solution of the conformal geometric representation of the first circle and includes a summation of movement of the first circle resulting in the center of the first circle coinciding with the center of the second circle, j represents an index of a number of the one or more movable joints n of the robotic arm, Lⱼ′ represents a transformed line in terms of an axis of rotation of each respective one of the one or more movable joints n of the robotic arm, and dqⱼ represents a differential that indicates how an angle qⱼ of each respective one of the one or more movable joints n of the robotic arm changes to result in the center of the first circle coinciding with the center of the second circle. In addition or in alternative to and in any combination with the optional features previously explained in this paragraph, the processing circuitry is configured to execute the computer-readable instructions to modify the initial set of control data to generate a revised set of control data to control the robotic arm. In addition or in alternative to and in any combination with the optional features previously explained in this paragraph, the processing circuitry is configured to execute the computer-readable instructions to generate the revised set of control data by adjusting each of the respective joint angles of the one or more movable joints in accordance with a minimization of a loss function.

### VII. General Operation of a Non-Transitory Computer-Readable Medium

A non-transitory computer-readable medium is provided. The non-transitory computer-readable medium is configured to store instructions thereon that, when executed by processing circuitry of a robotic controller, cause the robotic controller to: calculate a current pose of a robotic arm comprising one or more movable joints and an end effector that is modeled as a first conformal geometric entity comprising a first circle; calculate a target pose of the robotic arm to be positioned to perform a task with respect to a target object that is modeled as a second conformal geometric entity comprising a second circle; and control the robotic arm to move from the current pose to the target pose by adjusting respective joint angles of the one or more movable joints to direct a center of the first circle to coincide with a center of the second circle. In addition or in alternative to and in any combination with the optional features previously explained in this paragraph, the instructions, when executed by processing circuitry of the robotic controller, cause the robotic controller to control the robotic arm to move from the current pose to the target pose using differential kinematics. In addition or in alternative to and in any combination with the optional features previously explained in this paragraph, the instructions, when executed by processing circuitry of the robotic controller, cause the robotic controller to control the robotic arm to move from the current pose to the target pose by simultaneously computing a position and orientation of the first circle and the second circle. In addition or in alternative to and in any combination with the optional features previously explained in this paragraph, the instructions, when executed by processing circuitry of the robotic controller, cause the robotic controller to control the robotic arm using an initial set of control data that indicates each of the respective joint angles of the one or more movable joints.

In addition or in alternative to and in any combination with the optional features previously explained in this paragraph, the instructions, when executed by processing circuitry of the robotic controller, cause the robotic controller to control the robotic arm by generating an initial set of control data by evaluating: dzₚ′=Σⱼ₌₁ⁿ[zₚ′∘Lⱼ′]dqⱼ, zₚ′ represents a conformal geometric representation of the first circle, dzₚ′ represents a differential kinematics motion solution of the conformal geometric representation of the first circle and includes a summation of movement of the first circle resulting in the center of the first circle coinciding with the center of the second circle, j represents an index of a number of the one or more movable joints n of the robotic arm, Lⱼ′ represents a transformed line in terms of an axis of rotation of each respective one of the one or more movable joints n of the robotic arm, and dqⱼ represents a differential that indicates how an angle qⱼ of each respective one of the one or more movable joints n of the robotic arm changes to result in the center of the first circle coinciding with the center of the second circle. In addition or in alternative to and in any combination with the optional features previously explained in this paragraph, the instructions, when executed by processing circuitry of the robotic controller, cause the robotic controller to modify the initial set of control data to generate a revised set of control data to control the robotic arm. In addition or in alternative to and in any combination with the optional features previously explained in this paragraph, the instructions, when executed by processing circuitry of the robotic controller, cause the robotic controller to generate the revised set of control data by adjusting each of the respective joint angles of the one or more movable joints in accordance with a minimization of a loss function.

### VIII. General Operation of a Robotic System

A robotic system is provided. The robotic system comprises: a robotic arm comprising one or more movable joints and an end effector; and a controller configured to control the robotic arm by: calculating a current pose of the robotic arm; modeling the end effector as a first conformal geometric entity comprising a first circle; calculating a target pose of the robotic arm to be positioned to perform a task at a target location; modeling the target location as a second conformal geometric entity comprising a second circle; and calculating control data to cause the robotic arm to move from the current pose to the target pose by adjusting respective joint angles of the one or more movable joints to direct a center of the first circle to coincide with a center of the second circle. In addition or in alternative to and in any combination with the optional features previously explained in this paragraph, the controller is configured to control the robotic arm to move from the current pose to the target pose using differential kinematics. In addition or in alternative to and in any combination with the optional features previously explained in this paragraph, the controller is configured to control the robotic arm to move from the current pose to the target pose by simultaneously computing a position and orientation of the first circle and the second circle. In addition or in alternative to and in any combination with the optional features previously explained in this paragraph, the controller is configured to control the robotic arm using an initial set of control data that indicates each of the respective joint angles of the one or more movable joints. In addition or in alternative to and in any combination with the optional features previously explained in this paragraph, the controller is configured to control the robotic arm by generating an initial set of control data by evaluating: dzₚ′=Σⱼ₌₁ⁿ[zₚ′∘Lⱼ′]dqⱼ, zₚ′ represents a conformal geometric representation of the first circle, dzₚ′ represents a differential kinematics motion solution of the conformal geometric representation of the first circle and includes a summation of movement of the first circle resulting in the center of the first circle coinciding with the center of the second circle, j represents an index of a number of the one or more movable joints n of the robotic arm, Lⱼ′ represents a transformed line in terms of an axis of rotation of each respective one of the one or more movable joints n of the robotic arm, and dqⱼ represents a differential that indicates how an angle qⱼ of each respective one of the one or more movable joints n of the robotic arm changes to result in the center of the first circle coinciding with the center of the second circle. In addition or in alternative to and in any combination with the optional features previously explained in this paragraph, the controller is configured to modify the initial set of control data to generate a revised set of control data to control the robotic arm by adjusting each of the respective joint angles of the one or more movable joints in accordance with a minimization of a loss function.

### Examples

The following examples pertain to various techniques of the present disclosure.

An example (e.g. example 1) is directed to a computing device, comprising: a memory configured to store computer-readable instructions; and processing circuitry configured to execute the computer-readable instructions to cause the computing device to: calculate a current pose of a robotic arm comprising one or more movable joints and an end effector that is modeled as a first conformal geometric entity comprising a first circle; calculate a target pose of the robotic arm to be positioned to perform a task with respect to a target object that is modeled as a second conformal geometric entity comprising a second circle; and control the robotic arm to move from the current pose to the target pose by adjusting respective joint angles of the one or more movable joints to direct a center of the first circle to coincide with a center of the second circle.

Another example (e.g. example 2), relates to a previously-described example (e.g. example 1), wherein the processing circuitry is configured to execute the computer-readable instructions to control the robotic arm to move from the current pose to the target pose using differential kinematics.

Another example (e.g. example 3) relates to a previously-described example (e.g. one or more of examples 1-2), wherein the processing circuitry is configured to execute the computer-readable instructions to control the robotic arm to move from the current pose to the target pose by simultaneously computing a position and orientation of the first circle and the second circle.

Another example (e.g. example 4) relates to a previously-described example (e.g. one or more of examples 1-3), wherein the processing circuitry is configured to execute the computer-readable instructions to control the robotic arm using an initial set of control data that indicates each of the respective joint angles of the one or more movable joints.

Another example (e.g. example 5) relates to a previously-described example (e.g. one or more of examples 1-4), wherein the processing circuitry is configured to execute the computer-readable instructions to control the robotic arm by generating an initial set of control data by evaluating:

dzₚ′=Σⱼ₌₁ⁿ[zₚ′∘Lⱼ′]dqⱼ, wherein:
zₚ′ represents a conformal geometric representation of the first circle,
dzₚ′ represents a differential kinematics motion solution of the conformal geometric representation of the first circle and includes a summation of movement of the first circle resulting in the center of the first circle coinciding with the center of the second circle,
j represents an index of a number of the one or more movable joints n of the robotic arm,
Lⱼ′ represents a transformed line in terms of an axis of rotation of each respective one of the one or more movable joints n of the robotic arm, and
dqⱼ represents a differential that indicates how an angle qⱼ of each respective one of the one or more movable joints n of the robotic arm changes to result in the center of the first circle coinciding with the center of the second circle.

Another example (e.g. example 6) relates to a previously-described example (e.g. one or more of examples 1-5), wherein the processing circuitry is configured to execute the computer-readable instructions to modify the initial set of control data to generate a revised set of control data to control the robotic arm.

Another example (e.g. example 7) relates to a previously-described example (e.g. one or more of examples 1-6), wherein the processing circuitry is configured to execute the computer-readable instructions to generate the revised set of control data by adjusting each of the respective joint angles of the one or more movable joints in accordance with a minimization of a loss function.

An example (e.g. example 8) is directed to a non-transitory computer-readable medium configured to store instructions thereon that, when executed by processing circuitry of a robotic controller, cause the robotic controller to: calculate a current pose of a robotic arm comprising one or more movable joints and an end effector that is modeled as a first conformal geometric entity comprising a first circle; calculate a target pose of the robotic arm to be positioned to perform a task with respect to a target object that is modeled as a second conformal geometric entity comprising a second circle; and control the robotic arm to move from the current pose to the target pose by adjusting respective joint angles of the one or more movable joints to direct a center of the first circle to coincide with a center of the second circle.

Another example (e.g. example 9), relates to a previously-described example (e.g. example 8), wherein the instructions, when executed by processing circuitry of the robotic controller, cause the robotic controller to control the robotic arm to move from the current pose to the target pose using differential kinematics.

Another example (e.g. example 10) relates to a previously-described example (e.g. one or more of examples 8-9), wherein the instructions, when executed by processing circuitry of the robotic controller, cause the robotic controller to control the robotic arm to move from the current pose to the target pose by simultaneously computing a position and orientation of the first circle and the second circle.

Another example (e.g. example 11) relates to a previously-described example (e.g. one or more of examples 8-10), wherein the instructions, when executed by processing circuitry of the robotic controller, cause the robotic controller to control the robotic arm using an initial set of control data that indicates each of the respective joint angles of the one or more movable joints.

Another example (e.g. example 12) relates to a previously-described example (e.g. one or more of examples 8-11), wherein the instructions, when executed by processing circuitry of the robotic controller, cause the robotic controller to control the robotic arm by generating an initial set of control data by evaluating:

dzₚ′=Σⱼ₌₁ⁿ[zₚ′∘Lⱼ′]dqⱼ, wherein:
zₚ′ represents a conformal geometric representation of the first circle,
dzₚ′ represents a differential kinematics motion solution of the conformal geometric representation of the first circle and includes a summation of movement of the first circle resulting in the center of the first circle coinciding with the center of the second circle,
j represents an index of a number of the one or more movable joints n of the robotic arm,
Lⱼ′ represents a transformed line in terms of an axis of rotation of each respective one of the one or more movable joints n of the robotic arm, and
dqⱼ represents a differential that indicates how an angle qⱼ of each respective one of the one or more movable joints n of the robotic arm changes to result in the center of the first circle coinciding with the center of the second circle.

Another example (e.g. example 13) relates to a previously-described example (e.g. one or more of examples 8-12), wherein the instructions, when executed by processing circuitry of the robotic controller, cause the robotic controller to modify the initial set of control data to generate a revised set of control data to control the robotic arm.

Another example (e.g. example 14) relates to a previously-described example (e.g. one or more of examples 8-13), wherein the instructions, when executed by processing circuitry of the robotic controller, cause the robotic controller to generate the revised set of control data by adjusting each of the respective joint angles of the one or more movable joints in accordance with a minimization of a loss function.

An example (e.g. example 15) is directed to a robotic system, comprising: a robotic arm comprising one or more movable joints and an end effector; and a controller configured to control the robotic arm by: calculating a current pose of the robotic arm; modeling the end effector as a first conformal geometric entity comprising a first circle; calculating a target pose of the robotic arm to be positioned to perform a task at a target location; modeling the target location as a second conformal geometric entity comprising a second circle; and calculating control data to cause the robotic arm to move from the current pose to the target pose by adjusting respective joint angles of the one or more movable joints to direct a center of the first circle to coincide with a center of the second circle.

Another example (e.g. example 16), relates to a previously-described example (e.g. example 15), wherein the controller is configured to control the robotic arm to move from the current pose to the target pose using differential kinematics.

Another example (e.g. example 17) relates to a previously-described example (e.g. one or more of examples 15-16), wherein the controller is configured to control the robotic arm to move from the current pose to the target pose by simultaneously computing a position and orientation of the first circle and the second circle.

Another example (e.g. example 18) relates to a previously-described example (e.g. one or more of examples 15-17), wherein the controller is configured to control the robotic arm using an initial set of control data that indicates each of the respective joint angles of the one or more movable joints.

Another example (e.g. example 19) relates to a previously-described example (e.g. one or more of examples 15-18), wherein the controller is configured to control the robotic arm by generating an initial set of control data by evaluating:

dzₚ′=Σⱼ₌₁ⁿ[zₚ′∘Lⱼ′]dqⱼ, wherein:
zₚ′ represents a conformal geometric representation of the first circle,
dzₚ′ represents a differential kinematics motion solution of the conformal geometric representation of the first circle and includes a summation of movement of the first circle resulting in the center of the first circle coinciding with the center of the second circle,
j represents an index of a number of the one or more movable joints n of the robotic arm,
Lⱼ′ represents a transformed line in terms of an axis of rotation of each respective one of the one or more movable joints n of the robotic arm, and
dqⱼ represents a differential that indicates how an angle qⱼ of each respective one of the one or more movable joints n of the robotic arm changes to result in the center of the first circle coinciding with the center of the second circle.

Another example (e.g. example 20) relates to a previously-described example (e.g. one or more of examples 15-19), wherein the controller is configured to modify the initial set of control data to generate a revised set of control data to control the robotic arm by adjusting each of the respective joint angles of the one or more movable joints in accordance with a minimization of a loss function.

An example (e.g. example 21) is directed to a computing device, comprising: a memory configured to store computer-readable instructions; and processing means for executing the computer-readable instructions to cause the computing device to: calculate a current pose of a robotic arm comprising one or more movable joints and an end effector that is modeled as a first conformal geometric entity comprising a first circle; calculate a target pose of the robotic arm to be positioned to perform a task with respect to a target object that is modeled as a second conformal geometric entity comprising a second circle; and control the robotic arm to move from the current pose to the target pose by adjusting respective joint angles of the one or more movable joints to direct a center of the first circle to coincide with a center of the second circle.

Another example (e.g. example 22), relates to a previously-described example (e.g. example 21), wherein the processing means executes the computer-readable instructions to control the robotic arm to move from the current pose to the target pose using differential kinematics.

Another example (e.g. example 23) relates to a previously-described example (e.g. one or more of examples 21-22), wherein the processing means executes the computer-readable instructions to control the robotic arm to move from the current pose to the target pose by simultaneously computing a position and orientation of the first circle and the second circle.

Another example (e.g. example 24) relates to a previously-described example (e.g. one or more of examples 21-23), wherein the processing means executes the computer-readable instructions to control the robotic arm using an initial set of control data that indicates each of the respective joint angles of the one or more movable joints.

Another example (e.g. example 25) relates to a previously-described example (e.g. one or more of examples 21-24), wherein the processing means executes the computer-readable instructions to control the robotic arm by generating an initial set of control data by evaluating:

dzₚ′=Σⱼ₌₁ⁿ[zₚ′∘Lⱼ′]dqⱼ, wherein:
zₚ′ represents a conformal geometric representation of the first circle,
dzₚ′ represents a differential kinematics motion solution of the conformal geometric representation of the first circle and includes a summation of movement of the first circle resulting in the center of the first circle coinciding with the center of the second circle,
j represents an index of a number of the one or more movable joints n of the robotic arm,
Lⱼ′ represents a transformed line in terms of an axis of rotation of each respective one of the one or more movable joints n of the robotic arm, and
dqⱼ represents a differential that indicates how an angle qⱼ of each respective one of the one or more movable joints n of the robotic arm changes to result in the center of the first circle coinciding with the center of the second circle.

Another example (e.g. example 26) relates to a previously-described example (e.g. one or more of examples 21-25), wherein the processing means executes the computer-readable instructions to modify the initial set of control data to generate a revised set of control data to control the robotic arm.

Another example (e.g. example 27) relates to a previously-described example (e.g. one or more of examples 21-26), wherein the processing means executes the computer-readable instructions to generate the revised set of control data by adjusting each of the respective joint angles of the one or more movable joints in accordance with a minimization of a loss function.

An example (e.g. example 28) is directed to a non-transitory computer-readable medium configured to store instructions thereon that, when executed by processing means of a robotic controller means, cause the robotic controller means to: calculate a current pose of a robotic arm comprising one or more movable joints and an end effector that is modeled as a first conformal geometric entity comprising a first circle; calculate a target pose of the robotic arm to be positioned to perform a task with respect to a target object that is modeled as a second conformal geometric entity comprising a second circle; and control the robotic arm to move from the current pose to the target pose by adjusting respective joint angles of the one or more movable joints to direct a center of the first circle to coincide with a center of the second circle.

Another example (e.g. example 29), relates to a previously-described example (e.g. example 28), wherein the instructions, when executed by processing means of the robotic controller means, cause the robotic controller means to control the robotic arm to move from the current pose to the target pose using differential kinematics.

Another example (e.g. example 30) relates to a previously-described example (e.g. one or more of examples 28-29), wherein the instructions, when executed by processing means of the robotic controller means, cause the robotic controller means to control the robotic arm to move from the current pose to the target pose by simultaneously computing a position and orientation of the first circle and the second circle.

Another example (e.g. example 31) relates to a previously-described example (e.g. one or more of examples 28-30), wherein the instructions, when executed by processing means of the robotic controller means, cause the robotic controller means to control the robotic arm using an initial set of control data that indicates each of the respective joint angles of the one or more movable joints.

Another example (e.g. example 32) relates to a previously-described example (e.g. one or more of examples 28-31), wherein the instructions, when executed by processing means of the robotic controller means, cause the robotic controller means to control the robotic arm by generating an initial set of control data by evaluating:

dzₚ′=Σⱼ₌₁ⁿ[zₚ′∘Lⱼ′]dqⱼ, wherein:
zₚ′ represents a conformal geometric representation of the first circle,
dzₚ′ represents a differential kinematics motion solution of the conformal geometric representation of the first circle and includes a summation of movement of the first circle resulting in the center of the first circle coinciding with the center of the second circle,
j represents an index of a number of the one or more movable joints n of the robotic arm,
Lⱼ′ represents a transformed line in terms of an axis of rotation of each respective one of the one or more movable joints n of the robotic arm, and
dqⱼ represents a differential that indicates how an angle qⱼ of each respective one of the one or more movable joints n of the robotic arm changes to result in the center of the first circle coinciding with the center of the second circle.

Another example (e.g. example 33) relates to a previously-described example (e.g. one or more of examples 28-32), wherein the instructions, when executed by processing means of the robotic controller means, cause the robotic controller means to modify the initial set of control data to generate a revised set of control data to control the robotic arm.

Another example (e.g. example 34) relates to a previously-described example (e.g. one or more of examples 28-33), wherein the instructions, when executed by processing means of the robotic controller means, cause the robotic controller means to generate the revised set of control data by adjusting each of the respective joint angles of the one or more movable joints in accordance with a minimization of a loss function.

An example (e.g. example 35) is directed to a robotic system, comprising: a robotic arm comprising one or more movable joints and an end effector; and a controller means for controlling the robotic arm by: calculating a current pose of the robotic arm; modeling the end effector as a first conformal geometric entity comprising a first circle; calculating a target pose of the robotic arm to be positioned to perform a task at a target location; modeling the target location as a second conformal geometric entity comprising a second circle; and calculating control data to cause the robotic arm to move from the current pose to the target pose by adjusting respective joint angles of the one or more movable joints to direct a center of the first circle to coincide with a center of the second circle.

Another example (e.g. example 36), relates to a previously-described example (e.g. example 35), wherein the controller means controls the robotic arm to move from the current pose to the target pose using differential kinematics.

Another example (e.g. example 37) relates to a previously-described example (e.g. one or more of examples 35-36), wherein the controller means controls the robotic arm to move from the current pose to the target pose by simultaneously computing a position and orientation of the first circle and the second circle.

Another example (e.g. example 38) relates to a previously-described example (e.g. one or more of examples 35-37), wherein the controller means controls the robotic arm using an initial set of control data that indicates each of the respective joint angles of the one or more movable joints.

Another example (e.g. example 39) relates to a previously-described example (e.g. one or more of examples 35-38), wherein the controller means controls the robotic arm by generating an initial set of control data by evaluating:

dzₚ′=Σⱼ₌₁ⁿ[zₚ′∘Lⱼ′]dqⱼ, wherein:
zₚ′ represents a conformal geometric representation of the first circle,
dzₚ′ represents a differential kinematics motion solution of the conformal geometric representation of the first circle and includes a summation of movement of the first circle resulting in the center of the first circle coinciding with the center of the second circle,
j represents an index of a number of the one or more movable joints n of the robotic arm,
Lⱼ′ represents a transformed line in terms of an axis of rotation of each respective one of the one or more movable joints n of the robotic arm, and
dqⱼ represents a differential that indicates how an angle qⱼ of each respective one of the one or more movable joints n of the robotic arm changes to result in the center of the first circle coinciding with the center of the second circle.

Another example (e.g. example 40) relates to a previously-described example (e.g. one or more of examples 35-39), wherein the controller means modifies the initial set of control data to generate a revised set of control data to control the robotic arm by adjusting each of the respective joint angles of the one or more movable joints in accordance with a minimization of a loss function.

An apparatus as shown and described.

A method as shown and described.

### CONCLUSION

The embodiments described herein are by way of example and not limitation, and other embodiments may be implemented. For example, the various apparatuses (e.g. the AMRs and/or central controller) may perform specific functions and/or execute specific algorithms and/or instructions. These executable instructions and/or the resulting tasks may comprise additional embodiments with respect to the manner or method in which they are executed, independently of the particular component that is executing these processes/tasks.

The aforementioned description of the specific aspects will so fully reveal the general nature of the disclosure that others can, by applying knowledge within the skill of the art, readily modify and/or adapt for various applications such specific aspects, without undue experimentation, and without departing from the general concept of the present disclosure. Therefore, such adaptations and modifications are intended to be within the meaning and range of equivalents of the disclosed aspects, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References in the specification to “one aspect,” “an aspect,” “an exemplary aspect,” etc., indicate that the aspect described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it is submitted that it is within the knowledge of one skilled in the art to affect such feature, structure, or characteristic in connection with other aspects whether or not explicitly described.

The exemplary aspects described herein are provided for illustrative purposes, and are not limiting. Other exemplary aspects are possible, and modifications may be made to the exemplary aspects. Therefore, the specification is not meant to limit the disclosure. Rather, the scope of the disclosure is defined only in accordance with the following claims and their equivalents.

Aspects may be implemented in hardware (e.g., circuits), firmware, software, or any combination thereof. Aspects may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general purpose computer.

For the purposes of this discussion, the term “processing circuitry” or “processor circuitry” shall be understood to be circuit(s), processor(s), logic, or a combination thereof. For example, a circuit can include an analog circuit, a digital circuit, state machine logic, other structural electronic hardware, or a combination thereof. A processor can include a microprocessor, a digital signal processor (DSP), or other hardware processor. The processor can be “hard-coded” with instructions to perform corresponding function(s) according to aspects described herein. Alternatively, the processor can access an internal and/or external memory to retrieve instructions stored in the memory, which when executed by the processor, perform the corresponding function(s) associated with the processor, and/or one or more functions and/or operations related to the operation of a component having the processor included therein.

In one or more of the exemplary aspects described herein, processing circuitry can include memory that stores data and/or instructions. The memory can be any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM).

The memory can be non-removable, removable, or a combination of both.

What is claimed is:

1. A computing device, comprising:
a memory configured to store computer-readable instructions; and
processing circuitry configured to execute the computer-readable instructions to cause the computing device to:
calculate a current pose of a robotic arm comprising one or more movable joints and an end effector that is modeled as a first conformal geometric entity comprising a first circle;
calculate a target pose of the robotic arm to be positioned to perform a task with respect to a target object that is modeled as a second conformal geometric entity comprising a second circle; and
control the robotic arm to move from the current pose to the target pose by adjusting respective joint angles of the one or more movable joints to direct a center of the first circle to coincide with a center of the second circle.

2. The computing device of claim 1, wherein the processing circuitry is configured to execute the computer-readable instructions to control the robotic arm to move from the current pose to the target pose using differential kinematics.

3. The computing device of claim 1, wherein the processing circuitry is configured to execute the computer-readable instructions to control the robotic arm to move from the current pose to the target pose by simultaneously computing a position and orientation of the first circle and the second circle.

4. The computing device of claim 1, wherein the processing circuitry is configured to execute the computer-readable instructions to control the robotic arm using an initial set of control data that indicates each of the respective joint angles of the one or more movable joints.

5. The computing device of claim 1, wherein the processing circuitry is configured to execute the computer-readable instructions to control the robotic arm by generating an initial set of control data by evaluating:
dzₚ′=Σⱼ₌₁ⁿ[zₚ′∘Lⱼ′]dqⱼ, wherein:
zₚ′ represents a conformal geometric representation of the first circle,
dzₚ′ represents a differential kinematics motion solution of the conformal geometric representation of the first circle and includes a summation of movement of the first circle resulting in the center of the first circle coinciding with the center of the second circle,
j represents an index of a number of the one or more movable joints n of the robotic arm,
Lⱼ′ represents a transformed line in terms of an axis of rotation of each respective one of the one or more movable joints n of the robotic arm, and
dqⱼ represents a differential that indicates how an angle qⱼ of each respective one of the one or more movable joints n of the robotic arm changes to result in the center of the first circle coinciding with the center of the second circle.

6. The computing device of claim 4, wherein the processing circuitry is configured to execute the computer-readable instructions to modify the initial set of control data to generate a revised set of control data to control the robotic arm.

7. The computing device of claim 6, wherein the processing circuitry is configured to execute the computer-readable instructions to generate the revised set of control data by adjusting each of the respective joint angles of the one or more movable joints in accordance with a minimization of a loss function.

8. A non-transitory computer-readable medium configured to store instructions thereon that, when executed by processing circuitry of a robotic controller, cause the robotic controller to:
calculate a current pose of a robotic arm comprising one or more movable joints and an end effector that is modeled as a first conformal geometric entity comprising a first circle;
calculate a target pose of the robotic arm to be positioned to perform a task with respect to a target object that is modeled as a second conformal geometric entity comprising a second circle; and
control the robotic arm to move from the current pose to the target pose by adjusting respective joint angles of the one or more movable joints to direct a center of the first circle to coincide with a center of the second circle.

9. The non-transitory computer-readable medium of claim 8, wherein the instructions, when executed by processing circuitry of the robotic controller, cause the robotic controller to control the robotic arm to move from the current pose to the target pose using differential kinematics.

10. The non-transitory computer-readable medium of claim 8, wherein the instructions, when executed by processing circuitry of the robotic controller, cause the robotic controller to control the robotic arm to move from the current pose to the target pose by simultaneously computing a position and orientation of the first circle and the second circle.

11. The non-transitory computer-readable medium of claim 8, wherein the instructions, when executed by processing circuitry of the robotic controller, cause the robotic controller to control the robotic arm using an initial set of control data that indicates each of the respective joint angles of the one or more movable joints.

12. The non-transitory computer-readable medium of claim 8, wherein the instructions, when executed by processing circuitry of the robotic controller, cause the robotic controller to control the robotic arm by generating an initial set of control data by evaluating:
dzₚ′=Σⱼ₌₁ⁿ[zₚ′∘Lⱼ′]dqⱼ, wherein:
zₚ′ represents a conformal geometric representation of the first circle,
dzₚ′ represents a differential kinematics motion solution of the conformal geometric representation of the first circle and includes a summation of movement of the first circle resulting in the center of the first circle coinciding with the center of the second circle,
j represents an index of a number of the one or more movable joints n of the robotic arm,
Lⱼ′ represents a transformed line in terms of an axis of rotation of each respective one of the one or more movable joints n of the robotic arm, and
dqⱼ represents a differential that indicates how an angle qⱼ of each respective one of the one or more movable joints n of the robotic arm changes to result in the center of the first circle coinciding with the center of the second circle.

13. The non-transitory computer-readable medium of claim 11, wherein the instructions, when executed by processing circuitry of the robotic controller, cause the robotic controller to modify the initial set of control data to generate a revised set of control data to control the robotic arm.

14. The non-transitory computer-readable medium of claim 13, wherein the instructions, when executed by processing circuitry of the robotic controller, cause the robotic controller to generate the revised set of control data by adjusting each of the respective joint angles of the one or more movable joints in accordance with a minimization of a loss function.

15. A robotic system, comprising:
a robotic arm comprising one or more movable joints and an end effector; and
a controller configured to control the robotic arm by:
calculating a current pose of the robotic arm;
modeling the end effector as a first conformal geometric entity comprising a first circle;
calculating a target pose of the robotic arm to be positioned to perform a task at a target location;
modeling the target location as a second conformal geometric entity comprising a second circle; and
calculating control data to cause the robotic arm to move from the current pose to the target pose by adjusting respective joint angles of the one or more movable joints to direct a center of the first circle to coincide with a center of the second circle.

16. The robotic system of claim 15, wherein the controller is configured to control the robotic arm to move from the current pose to the target pose using differential kinematics.

17. The robotic system of claim 15, wherein the controller is configured to control the robotic arm to move from the current pose to the target pose by simultaneously computing a position and orientation of the first circle and the second circle.

18. The robotic system of claim 15, wherein the controller is configured to control the robotic arm using an initial set of control data that indicates each of the respective joint angles of the one or more movable joints.

19. The robotic system of claim 15, wherein the controller is configured to control the robotic arm by generating an initial set of control data by evaluating:
dzₚ′=Σⱼ₌₁ⁿ[zₚ′∘Lⱼ′]dqⱼ, wherein:
zₚ′ represents a conformal geometric representation of the first circle,
dzₚ′ represents a differential kinematics motion solution of the conformal geometric representation of the first circle and includes a summation of movement of the first circle resulting in the center of the first circle coinciding with the center of the second circle,
j represents an index of a number of the one or more movable joints n of the robotic arm,
Lⱼ′ represents a transformed line in terms of an axis of rotation of each respective one of the one or more movable joints n of the robotic arm, and
dqⱼ represents a differential that indicates how an angle qⱼ of each respective one of the one or more movable joints n of the robotic arm changes to result in the center of the first circle coinciding with the center of the second circle.

20. The robotic system of claim 18, wherein the controller is configured to modify the initial set of control data to generate a revised set of control data to control the robotic arm by adjusting each of the respective joint angles of the one or more movable joints in accordance with a minimization of a loss function.
